(19) United States
(12) Patent Application Publication
(10) Pub. No.: US 2021/0215281 A1
(43) Pub. Date: Jul. 15, 2021

(54) MOUNTING APPARATUS

(71) Applicant: Absolute Genius Limited, Derby (GB)

(72) Inventors: Christopher Jon Massey, Derby (GB); Paul Davidson, Derby (GB); Robert David Sankey, Derby (GB)

(21) Appl. No.: 17/059,291

(22) PCT Filed: Mar. 29, 2019
(86) PCT No.: PCT/GB2019/050914

§ 371 Date: Nov. 27, 2020

(30) Foreign Application Priority Data
May 28, 2018 (GB) 1808692.6
Jun. 25, 2018 (GB) 1810353.1
Jul. 3, 2018 (GB) 1810918.1
Jul. 11, 2018 (GB) 1811338.1

(51) Int. Cl. F16L 19/02

(52) U.S. Cl. CPC F16L 19/0206

(57) ABSTRACT

A mounting apparatus for mounting together a first pipe and a second pipe end to end. The mounting apparatus a first abutment member mountable on the first pipe at a predetermined distance from the end of the first pipe and a second abutment member mountable on the second pipe at a predetermined distance from the end of the second pipe. The apparatus further includes a sealing member locatable between the ends of the pipes and a tightening arrangement for urging the first and second abutment members mounted on the first and second pipes towards one another and thereby providing a seal between the pipes.

This invention concerns mounting apparatus for mounting together two pipes end to end, a joint between two pipes, and a method of joining two pipes end to end.

In a number of situations it is required to join two lengths of pipe together end to end to provide a continuous length of pipe. In some situations only limited space is available around such a joint. This can lead to difficulties in installing such a joint and also when its necessary to separate the lengths of pipe to for instance replace a seal. Only limited relative longitudinal movement of the pipe lengths may be possible which again can make the separation of the pipes difficult.

It is a requirement in many situations and for instance in food or drink production, pharmaceutical or chemical production, for such a joint to provide no obstruction to flow through the pipes, and also not to provide areas where material can build up, potentially leading to contamination or infection.

A number of prior arrangements have been proposed. One of these requires the mounting by welding of sleeves with end flanges on each pipe end. A seal is provided, which is often an O ring between the flanges, and a clamp engageable with chamfers on the flanges is provided for urging the flanges together. This is a relatively expensive solution, requiring a number of components. Once the sleeves have been welded to each pipe end, the pipe ends and sleeves require grinding and polishing, hence adding to the cost and work involved in providing such a joint. Also in practice it has been found that the seal once clamped tends to impinge into the interior of the pipes, therefore affecting the flow therethrough.

According to a first aspect of the disclosure there is provided a mounting apparatus for mounting together a first pipe and a second pipe end to end, the apparatus comprising: a first abutment member mountable on the first pipe at a predetermined distance from the end of the first pipe, the first abutment member being such as to grip the first pipe when mounted thereon; a second abutment member mountable on the second pipe at a predetermined distance from the end of the second pipe, the first abutment member being such as to grip the second pipe when mounted thereon; a sealing member locatable between the ends of the pipes; and a tightening arrangement for urging the first and second abutment members mounted on the first and second pipes towards one another, which tightening arrangement includes: a first surface for applying a first force to the first abutment member, thereby urging the first pipe towards the second pipe; a second surface for applying a second force to the second abutment member, thereby urging the second pipe towards the first pipe; and an adjustable connection for adjusting the first and second forces applied to the first and second abutment members to urge the first and second pipes towards one another.

The adjustable connection may be a threaded connection.

In some embodiments, the tightening arrangement includes a first housing member including the first surface and a through passage through which the pipes can slidingly extend, the first housing member through passage being locatable, with a first one of the pipes extending therethrough, on an opposite side of the first abutment member to the end of the first pipe; and a second housing member including the second surface and a through passage through which the pipes can slidingly extend, the second housing member being locatable on an opposite side of the second abutment member to the end of the second pipe.

The first and second housing members may be threadingly engageable together by the threaded connection, such that as the first and second housing members are threadingly moved together the first surface engages against the first abutment member to apply the first force, and the second surface engages against the first abutment member to apply the second force.

The housing members may each include a flange and the tightening arrangement may comprise an enclosing clamp, which enclosing clamp includes the adjustable connection and the first and second surfaces, wherein the enclosing clamp is mountable to the flanges on the housing members.

The abutment members may each include a flange and the tightening arrangement may comprise an enclosing clamp, which enclosing clamp includes the adjustable connection and the first and second surfaces, wherein the enclosing clamp is mountable to the flanges on the abutment members.

The flanges may each include a bevelled surface for engagement by the first and second surfaces of the enclosing clamp.

The housing members may have threads such that ends of one or more of the threads will be reached at a required amount of tightening together of the housing members.

The abutment members may be in the form of grip rings which grip on a pipe. The grip rings may be configured such that when an axial force is applied to a grip ring provided on a pipe, in one direction, this causes the grip ring to grip harder against the pipe.

The grip rings may grip against a circumferential indent in a pipe.

A holding member may be provided for holding an abutment member as it is slid onto a pipe to the predetermined distance.

A guide arrangement may be provided for use with forming an indent in a pipe at a predetermined distance from the pipe end.

A sleeve member may be locatable around the pipes between the abutment members.

A separate sleeve member may be provided on each pipe. A non-continuous ring may be provided on a one of the pipes, which ring can be selectively radially removed from a pipe.

The sealing member may be made of plastics material and may be made of PTFE.

The abutment member may be made of a material that is softer than stainless steel, and may be made from copper or brass.

A still further aspect of the disclosure provides a method of joining two pipes end to end, the method comprising providing mounting apparatus according to any of the preceding sixteen paragraphs on an end of the two pipes, and adjusting the adjustable connection to urge the two pipes together.

Prior to adjusting the adjustable connection, indents may be provided on the pipes at the predetermined distances from the pipe ends.

Prior to adjusting the adjustable connection, the abutment members may be mounted on the pipes.

Prior to mounting the abutment members to the pipes, the abutment members may be heated to cause the abutment members to expand.

According to a still further aspect of the disclosure there is provided a joint between two pipes, the joint being formed of apparatus according to any of said preceding sixteen paragraphs.

Embodiments of the present invention will now be described by way of example only and with reference to the accompanying drawings, in which:

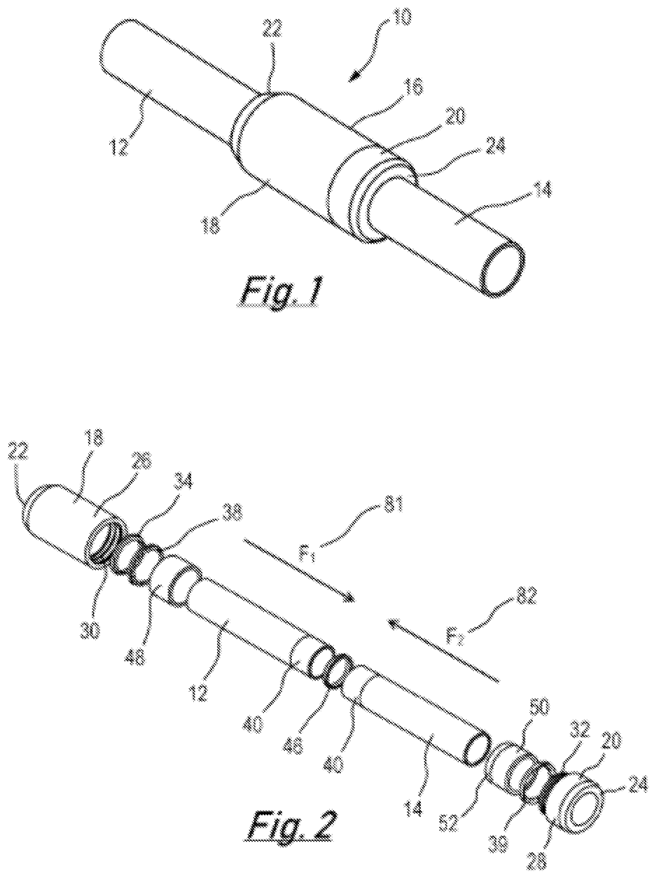

FIG. 1 is a diagrammatic perspective view of a first joint;

FIG. 2 is an exploded perspective view of the joint of FIG. 1, with the directions of two forces shown;

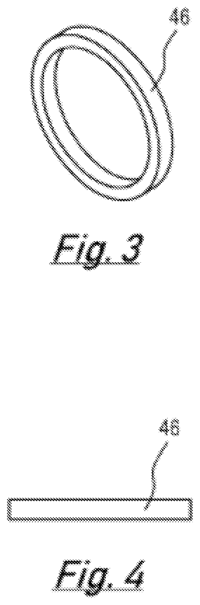

FIG. 3 is a diagrammatic perspective view of a first component of the joint of FIG. 1;

FIG. 4 is a diagrammatic side view of the first component;

FIG. 5 is an end view of a second component of the joint of FIG. 1;

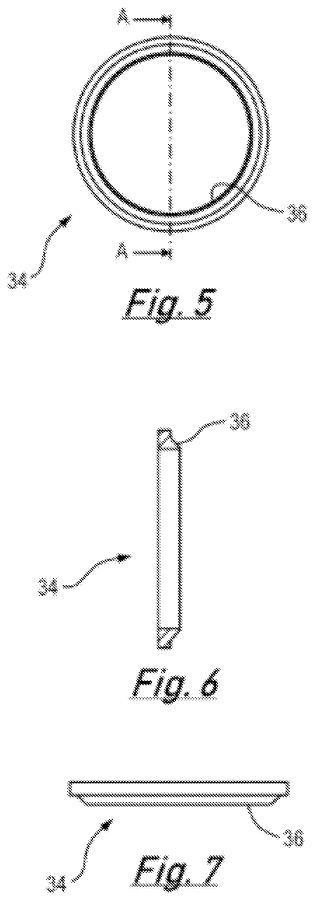

FIG. 6 is a cross sectional view along the line A-A of FIG. 5;

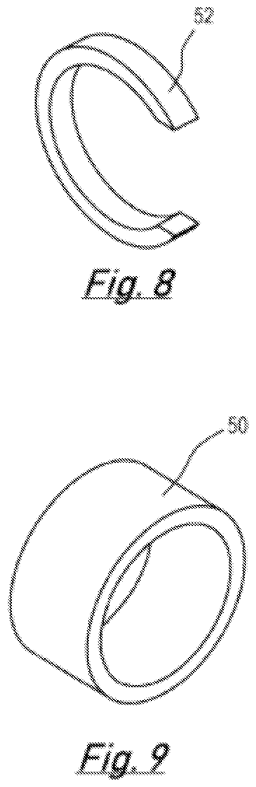

FIG. 7 is a diagrammatic side view of the second component;

FIG. 8 is a diagrammatic perspective view of a third component of the joint of FIG. 1;

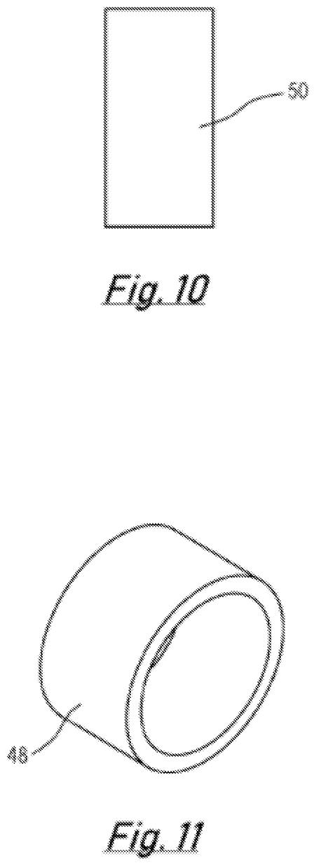

FIG. 9 is a diagrammatic perspective view of a fourth component of the joint of FIG. 1;

FIG. 10 is a diagrammatic side view of the fourth component;

FIG. 11 is a diagrammatic perspective view of a fifth component of the joint of FIG. 1;

FIG. 12 is a diagrammatic perspective view of the fifth component;

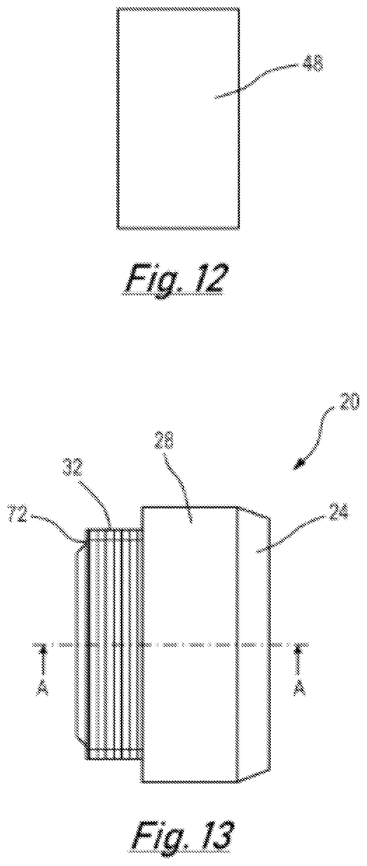

FIG. 13 is a diagrammatic side view of a sixth component of the joint of FIG. 1;

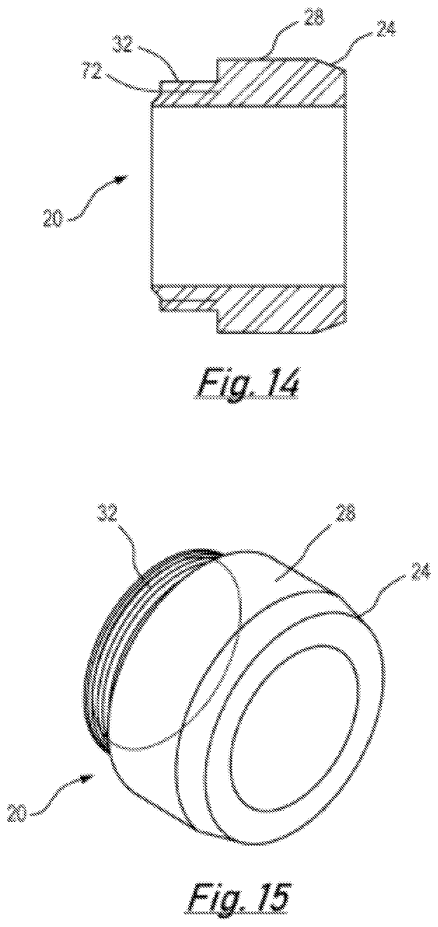

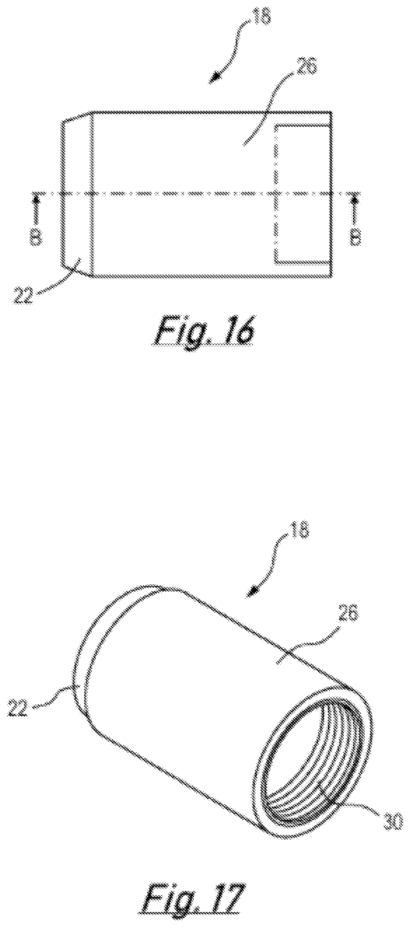

FIG. 14 is a diagrammatic cross sectional view along the line A-A of FIG. 15;

FIG. 15 is a diagrammatic perspective end view of the sixth component;

FIG. 16 is a diagrammatic side view of an seventh component of the joint of FIG. 1;

FIG. 17 is a diagrammatic perspective end view of the seventh component;

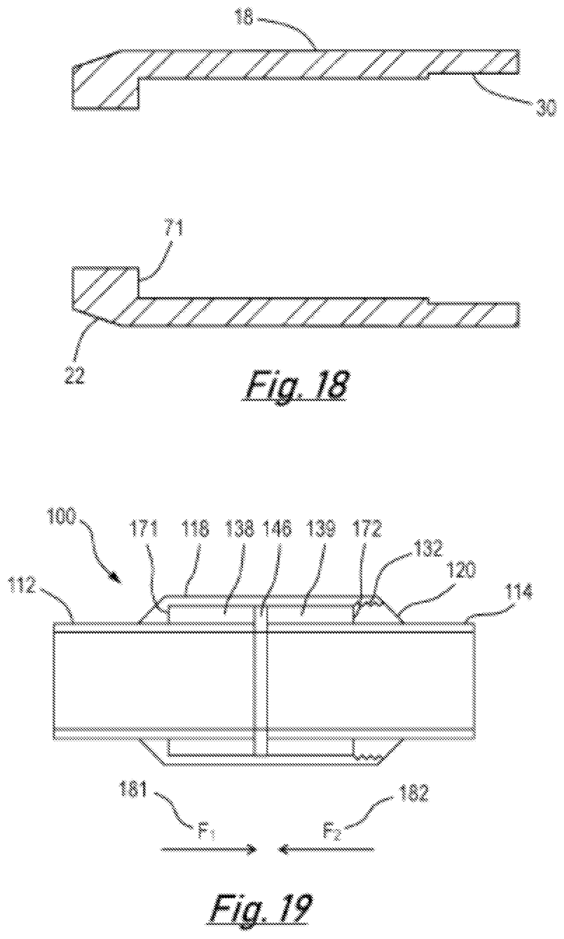

FIG. 18 is a cross-sectional view of the seventh component;

FIG. 19 is a diagrammatic cross-sectional view of a second joint, with the directions of two forces shown;

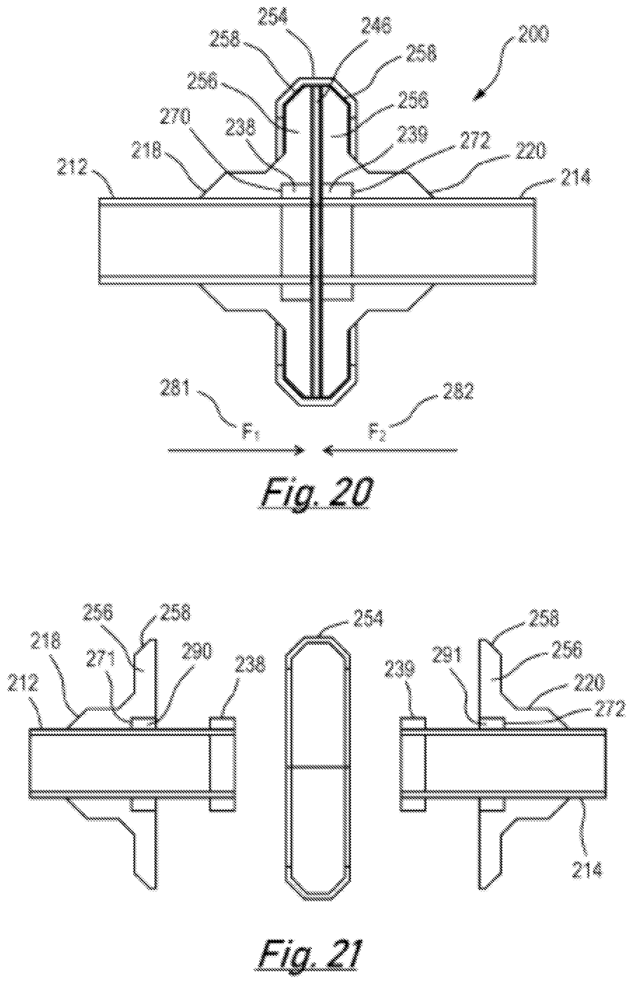

FIG. 20 is a diagrammatic cross-sectional view of a third joint, with the directions of two forces shown;

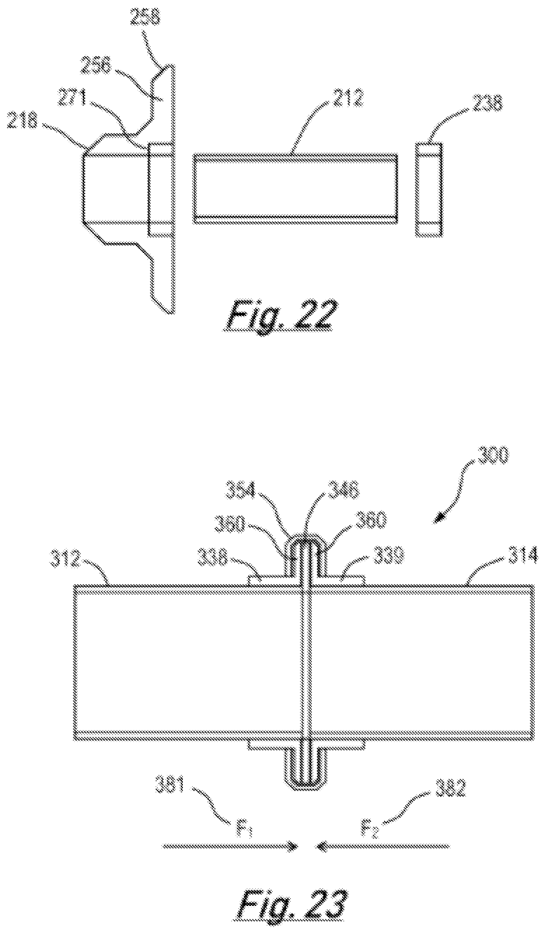

FIG. 21 is a partially exploded diagrammatic cross-sectional view of the third joint;

FIG. 22 is an exploded diagrammatic cross-sectional view of a first component of the third joint;

FIG. 23 is a diagrammatic cross-sectional view of a fourth joint, with the directions of two forces shown; and

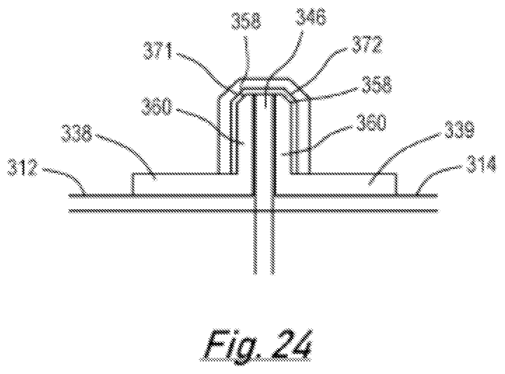

FIG. 24 is an enlarged view of FIG. 23 showing the fourth joint.

FIGS. 1 to 20 show a first joint 10 and the components used in the joint 10, for mounting together the ends of a first pipe 12 and a second pipe 14, with only end portions of the pipes 12, 14 being shown for clarity. The joint 10 includes a tightening arrangement comprising a two part housing 16 with a first longer female part 18, and a second shorter male part 20. Each housing member 18, 20 is such as to be a sliding fit on the pipes. The housing members 18, 20 each have a respective frustoconical end 22, 24 leading to a cylindrical body 26, 28, which is significantly longer on the female part 18 than the male part 20. An internal thread 30 is provided on the end of the cylindrical body 26 away from the frustoconical end 22 of the female part 18, whilst an external thread 32 is provided on the end of the male part 20 away from the frustoconical end 24. The two threads 30, 32 form an adjustable connection.

The housing members 18, 20 are slid respectively onto the pipes 12, 14 and moved away from the respective ends thereof.

Locatable in the female part 18 towards the frusto conical end 22 is a grip ring support 34 in the form of a ring which is a sliding fit on the pipes 12, 14, and has an outwardly inclined bevelled edge 36 on the side of the ring away from the frusto conical end 22.

An abutment member in the form of a grip ring 38, 39 is mounted on each pipe 12, 14 at a required distance from the end thereof, with a first grip ring 38 being mounted on the first pipe 12 and a second grip ring 39 being mounted on the second pipe 14. In this instance with metal pipes such as stainless steel pipes, a circumferential groove 40 is scored around the pipe at a required distance from the end thereof as shown. A special tool may be provided for this to provide the groove 40 at the required spacing from the pipe end.

The grip rings 38, 39 comprise an outer ring 42 with a plurality of inwardly inclined teeth 44 which are engageable in the groove 40 to mount the respective grip ring 38, 39 to the pipe. The grip rings 38, 39 as shown in FIG. 2, have the inclined teeth 44 towards the end of the respective pipe 12, 14. This means that in practice if urged towards the end of the pipe the grip rings will increase their grip on the respective pipe 12, 14.

A sealing member in the form of an annular seal 46 is provided locatable between the ends of the pipes 12, 14, and the annular seal 46 may be made of a plastics material such as PTFE.

A first longer sleeve 48 is provided which is locatable around the pipe 12 within the female housing member 18. The sleeve 48 is dimensioned such that initially the seal 46 may locate in an end of the sleeve 48 to aid location between the ends of the two pipes 12, 14.

A shorter similar sleeve 50 is locatable around the pipe 14 within the male housing member 20. A split ring 52 for example of a plastics material, is provided at the inner end of the shorter sleeve 50 and can readily be manually removed from the pipe 14.

In use the grip rings 38, 39 are mounted as outlined above, and a special tool may be provided to hold the grip rings 38, 39 as they are urged on to the pipe ends until they are engaged in the respective grooves 40. The sleeves 48, 50 and split ring 52 are located on the end of the pipes 12, 14 inside the grip rings 38, 39 mounted thereon.

The two housing members 18, 20 can then be moved together and threadingly engaged with each other to tighten the joint 10. In use, as the housing members 18, 20 are moved together, a first surface 71 inside the first housing member 18 engages against the first grip ring 38 and applies a first force 81 to it, thereby urging the first grip ring 38 (and the first pipe 12 to which it is mounted) towards the second pipe 14. At the same time, a second surface 72 positioned at the end of the thread 32 of the second housing member 20 engages against the second grip ring 39 and applies a second force 81 to it, thereby urging the second grip ring 39 (and the second pipe 14 to which it is mounted) towards the first pipe 12. The first and second forces 81, 82 are applied simultaneously and can be adjusted by threadingly rotating the first and/or second housing members 18, 20.

The extent of the threads 30, 32 on the housing members 18, 20 may be such as to provide a required tightening of the joint 10 but avoid over tightening.

If it is required to undo the joint 10, the housing members 18, 20 can be unscrewed from each other and slid apart. The split ring 52 can then be removed to provide access to the seal which can be pulled or pushed apart, for instance to enable the seal 46 to be replaced.

FIG. 21 shows a second joint 100, which includes a similar tightening arrangement to the first joint 10, with a first and second housing member 118, 120, which are threadingly engageable together by an adjustable connection. A sealing member 146 is locatable between the ends of first and second pipes 112, 114.

First and second abutment members 138, 139 in the form of rings are mountable on the respective first and second pipes 112, 114 at a required distance from the end thereof. In this instance the abutment members 138 are mounted at the ends of the respective pipes 112, 114.

In this example, the abutment members 138, 139 are in the form of metal rings and are mountable onto the respective pipes 112, 114 using a heat shrinking process, meaning that a groove in the pipe is not required to mount the abutment member 138, 139. For instance, an abutment member 138, 139 in the form of a brass or copper ring can be heated using an induction heater or other means, which expands the ring. The ring can then be placed onto the pipe at a required distance from the end thereof and allowed to cool. As the ring cools and shrinks, the ring grips onto the pipe. Brass or copper rings can be used as abutment members for stainless steel piping, as copper and brass are softer (measured for instance using the Brinell scale) than steel, and are therefore less likely to damage the steel piping when shrunk onto the piping. In some, but not necessarily all embodiments, the pipe may be cooled using coolants or other means, such that the pipe 112, 114 shrinks to enable the abutment member 138, 139 to be mounted thereon. In other embodiments, the abutment member 138, 139 may be mounted to the pipes using an adhesive.

In use, the housing members 118, 120 are slid onto the respective first and second pipes 112, 114 and moved away from the respective ends thereof, then the abutment members 138, 139 are mounted to the respective pipes 112, 114. As the housing members 118, 120 are threadingly engaged with each other to tighten the joint, a first surface 171 inside the first housing member 118 engages against the first abutment member 138 and applies a first force 181 to it, thereby urging the first abutment member 138 (and the first pipe 112 to which it is mounted) towards the second pipe 114. At the same time, a second surface 172 positioned at the end of the of the second housing member 120 engages against the second abutment member 139 and applies a second force 182 to it, thereby urging the second abutment member 139 (and the second pipe 114 to which it is mounted) towards the first pipe 112. The first and second forces 181, 182 can be adjusted by threadingly rotating the first and/or second housing members 118, 120.

FIGS. 22-24 show a third joint 200. This joint includes similar first and second abutment members 238, 239 to the second joint 100, which are mountable to respective first and second pipes 212, 214.

The third joint 200 includes first and second flanged housing members 218, 220, which in the example shown in FIGS. 21-23 do not include threaded portions for threaded engagement with each other. However, in some, but not necessarily all embodiments, the flanged housing members 218, 220 may include threaded portions to engage with one another in a similar fashion to the housing members 18, 20, 118, 120 of the first and second joints 10, 100.

The flanged housing members 218, 220 each include a circumferential flange 256, which flanges 256 each include a bevelled surface 258. The flanged housing members 218, 220 also each include a receiving portion 290, 291 for receiving the respective abutment member 238, 239.

A tightening arrangement is provided, which includes an enclosing clamp 254 and the housing members 218, 220. The enclosing clamp 254 is configured to urge the flanges 256 of the housing members 218, 220 together.

The enclosing clamp 254 is substantially similar to clamps used for the well-known Tri-clamp or Tri-clover fitting. The clamp 254 includes two c-shaped sections mounted to one another via a pivot. The pivot enables the two c-shaped sections to clamp around the circumferential flanges 256 of the housing members 218, 220. At the opposite side of the c-shaped sections to the pivot is an adjustable connection between the two c-shaped sections. The adjustable connection may be a threaded connection.

When the c-shaped sections of the enclosing clamp 254 are positioned around the circumferential flanges, the tightening of the adjustable connection causes an internal surface of the c-shaped sections to engage against the bevelled portions 258 of the flanges 256, urging the opposing housing members 218, 220 together. As the housing members 218, 220 are urged together, a first surface 271 inside the receiving portion 290 of the first housing member 218 engages against the first abutment member 238 and applies a first force 281, thereby urging the first abutment member 238 (and the first pipe 212 to which it is mounted) towards the second pipe 214. At the same time, a second surface 272 positioned inside the receiving portion 291 of the second housing member 220 engages against the second abutment member 239 and applies a second force 281, thereby urging the second abutment member 239 (and the second pipe 214 to which it is mounted) towards the first pipe 212. The first and second forces 281, 282 can be altered simultaneously by adjusting the adjustable connection of the enclosing clamp 254.

A sealing member 246 is provided locatable between the flanges 256 to seal the joint 200.

FIGS. 24 & 25 shows a fourth joint 300. This joint 300 includes first and second flanged abutment members 338, 339 mountable to respective first and second pipes 312, 314, along with an enclosing clamp 354, which is the same as the enclosing clamp 254 of joint 200.

The flanged abutment members 338, 339 may be in the form of circumferentially flanged rings, which may be mounted to and grip the pipes by the processes described previously, for instance by mechanical means or a friction fit (i.e. a grip ring or a ring attached using the heat shrink process described previously) or by use of an adhesive. The flanges 360 of the abutment members 338, 339 each include bevelled portions 358.

The enclosing clamp 354 provides a tightening arrangement. The enclosing clamp 354 is mountable to the flanged abutment members 338, 339. The internal engagement surface of the c-shaped sections of the enclosing clamp 354 provides a first surface 371 for applying a first force 381 to the first abutment member and a second surface 372 for applying a second force 382 to the second abutment member. The tightening of the adjustable connection of the enclosing clamp 354 causes the first surface 371 to engage against the bevelled portion 358 of the first abutment member 338, and the second surface 372 to engage against the bevelled portion 358 of the second abutment member 339, which urges the opposing abutment members 338 and pipes 312, 314 together. The first and second forces 381, 382 can be altered simultaneously by adjusting the adjustable connection of the enclosing clamp 354.

A sealing member 346 is provided locatable between the flanges 360 and pipes 312, 314 to seal the joint 200.

This therefore provides a readily usable joint and components usable therein, which enables two pipe ends to readily be joined together and also separated if required, by hand. The two pipe ends can be moved apart even in very cramped conditions, and could for instance be slid sideways away from each other. The apparatus is though of relatively conventional construction and can thus be inexpensively manufactured for long term use.

Various modifications can be made without departing from the scope of the invention. For instance different materials may be used. An adjustable connection other than a threaded connection may be used.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A mounting apparatus for mounting together a first pipe and a second pipe end to end, the apparatus comprising:
a first abutment member mountable on the first pipe at a predetermined distance from the end of the first pipe, the first abutment member being such as to grip the first pipe when mounted thereon;
a second abutment member mountable on the second pipe at a predetermined distance from the end of the second pipe, the first abutment member being such as to grip the second pipe when mounted thereon;
a sealing member locatable between the ends of the pipes; and
a tightening arrangement for urging the first and second abutment members mounted on the first and second pipes towards one another, which tightening arrangement includes:
a first surface for applying a first force to the first abutment member, thereby urging the first pipe towards the second pipe;
a second surface for applying a second force to the second abutment member, thereby urging the second pipe towards the first pipe; and
an adjustable connection for adjusting the first and second forces applied to the first and second abutment members to urge the first and second pipes towards one another.

2. A mounting apparatus according to claim 1, in which the adjustable connection is a threaded connection.

3. A mounting apparatus according to claim 2, in which the tightening arrangement includes a first housing member including the first surface and a through passage through which the pipes can slidingly extend, the first housing member through passage being locatable, with a first one of the pipes extending therethrough, on an opposite side of the first abutment member to the end of the first pipe; and a second housing member including the second surface and a through passage through which the pipes can slidingly extend, the second housing member being locatable on an opposite side of the second abutment member to the end of the second pipe.

4. A mounting apparatus according to claim 3, in which the first and second housing members are threadingly engageable together by the threaded connection, such that as the first and second housing members are threadingly moved together the first surface engages against the first abutment member to apply the first force, and the second surface engages against the first abutment member to apply the second force.

5. A mounting apparatus according to claim 3, in which the housing members each include a flange and the tightening arrangement comprises an enclosing clamp, which enclosing clamp includes the adjustable connection and the first and second surfaces, wherein the enclosing clamp is mountable to the flanges on the housing members.

6. A mounting apparatus according to claim 1, in which the abutment members each include a flange and the tightening arrangement comprises an enclosing clamp, which enclosing clamp includes the adjustable connection and the first and second surfaces, wherein the enclosing clamp is mountable to the flanges on the abutment members.

7. A mounting apparatus according to claim 6, in which the flanges each include a bevelled surface for engagement by the first and second surfaces of the enclosing clamp.

8. A mounting apparatus according to claim 3, in which the housing members have threads such that ends of one or more of the threads will be reached at a required amount of tightening together of the housing members.

9. A mounting apparatus according to claim 1, in which the abutment members are in the form of grip rings which grip on a pipe.

10. A mounting apparatus according to claim 9, in which the grip rings are configured such that when an axial force is applied to a grip ring provided on a pipe, in one direction, this causes the grip ring to grip harder against the pipe

11. A mounting apparatus according to claim 9, in which the grip rings grip against a circumferential indent in a pipe.

12. A mounting apparatus according to claim 1, in which a holding member is provided for holding an abutment member as it is slid onto a pipe to the predetermined distance.

13. A mounting apparatus according to claim 1, in which a guide arrangement is provided for use with forming an indent in a pipe at a predetermined distance from the pipe end.

14. A mounting apparatus according to claim 1, in which a sleeve member is locatable around the pipes between the abutment members.

15. A mounting apparatus according to claim 1, in which a non-continuous ring is provided on a one of the pipes, which ring can be selectively radially removed from a pipe.

16-17. (canceled)

18. A mounting apparatus according to claim 1, in which the abutment member is made of a material that is softer than stainless steel.

19. A method of joining two pipes end to end, the method comprising providing mounting apparatus according to claim 1 on an end of the two pipes, and adjusting the adjustable connection to urge the two pipes together.

20. A method according to claim 19, in which: prior to adjusting the adjustable connection, indents are provided on the pipes at the predetermined distances from the pipe ends.

21. A method according to claim 19, in which: prior to adjusting the adjustable connection, the abutment members are mounted on the pipes.

22. A method according to claim 21, in which: prior to mounting the abutment members to the pipes, the abutment members are heated to cause the abutment members to expand.

23. (canceled)
